(19) United States
(12) Patent Application Publication
(10) Pub. No.: US 2011/0064059 A1
(43) Pub. Date: Mar. 17, 2011

(54) Apparatuses, Methods and Computer Program for Cell Reselection Evaluation

(76) Inventors: Kari Juhani Hooli, Oulu (FI); Kari Veikko Horneman, Oulu (FI)

(21) Appl. No.: 12/992,619

(22) PCT Filed: May 22, 2008
(86) PCT No.: PCT/EP08/56313

§ 371 Date: Nov. 15, 2010

(51) Int. Cl. H04W 36/30

(52) U.S. Cl. 370/332

(57) ABSTRACT

The invention relates to an apparatus including a first cell evaluator configured to carry out a first cell reselection evaluation process; a cell analyzer configured to analyze a cell selected in the first cell reselection evaluation process and to trigger a second cell reselection evaluation process in a case the cell selected in the first cell reselection process is a relay node cell or a cell supported by a node which node also supports relay node cells, and the cell is within a same cell group than that of a serving cell; and a second cell evaluator configured to carry out the second cell reselection evaluation process.

### FIELD

The invention relates to an apparatuses, methods and a computer program for cell reselection evaluation.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

A main target of the presentation of a relay node concept is to extend coverage, e.g. by improving penetration inside buildings and enhancing coverage on building shadows. Additionally, relay node extension can also be used for improving high-bit-rate coverage, reducing average transmission power at a user device thus increasing battery life, and enhancing cell capacity and effective throughput, e.g., by increasing cell-edge capacity.

### BRIEF DESCRIPTION

According to an aspect of the present invention, there is provided an apparatus comprising: a first cell evaluator configured to carry out a first cell reselection evaluation process; a cell analyzer configured to analyze a cell selected in the first cell reselection evaluation process and to trigger a second cell reselection evaluation process in a case the cell selected in the first cell reselection process is a relay node cell or a cell supported by a node which node also supports relay node cells, and the cell is within a same cell group than that of a serving cell; and a second cell evaluator configured to carry out the second cell reselection evaluation process.

According to another aspect of the present invention, there is provided a method comprising: carrying out a first cell reselection evaluation process; analyzing a cell selected in the first cell reselection evaluation process and triggering a second cell reselection evaluation process in a case the cell selected in the first cell reselection process is a relay node cell or a cell supported by a node which node also supports relay node cells, the cell being within a same cell group than that of a serving cell; and carrying out the second cell reselection evaluation process.

According to another aspect of the present invention, there is provided an apparatus, comprising: a processor configured to prioritize relay node cells for a second cell reselection evaluation; a transmitter configured to signal the prioritizing information to relay nodes.

According to another aspect of the present invention, there is provided an apparatus comprising: means for carrying out a first cell reselection evaluation process; means for analyzing a cell selected in the first cell reselection evaluation process and triggering a second cell reselection evaluation process in a case the cell selected in the first cell reselection process is a relay node cell or a cell supported by a node which node also supports relay node cells within a same cell group than that of a serving cell; and means for carrying out the second cell reselection evaluation process.

According to another aspect of the present invention, there is provided an apparatus, comprising: means for prioritizing relay node cells for a second cell reselection evaluation; and means for signaling the prioritizing information to relay nodes.

According to another aspect of the present invention, there is provided a method comprising: prioritizing relay node cells for a second cell reselection evaluation; and signaling the prioritizing information to relay nodes.

### LIST OF DRAWINGS

Embodiments of the present invention are described below, by way of example only, with reference to the accompanying drawings, in which

FIG. 1 illustrates an example of a communication system;

FIGS. 2A and 2B are a flow charts;

FIG. 3 illustrates an example of an apparatus; and

FIG. 4 illustrates another example of an apparatus.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user terminal, server, corresponding component, and/or to any communication system or any combination of different communication systems that support the use of relay extensions. The communication system may be a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

Many different radio protocols to be used in communications systems exist. Some examples of different communication systems are the Universal Mobile Telecommunications System (UMTS) radio access network (UTRAN or E-UTRAN), Long Term Evolution (LTE, the same as E-UTRA), Long Term Evolution Advanced (LTE-A), Wireless Local Area Network (WLAN), Worldwide Interoperability for Microwave Access (WiMAX), Bluetooth®, Personal Communications Services (PCS) and systems using ultra-wideband (UWB) technology.

In the following, different embodiments will be described using, as an example of a system architecture whereto the embodiments may be applied, an architecture based on LTE systems without restricting the embodiment to such an architecture, however.

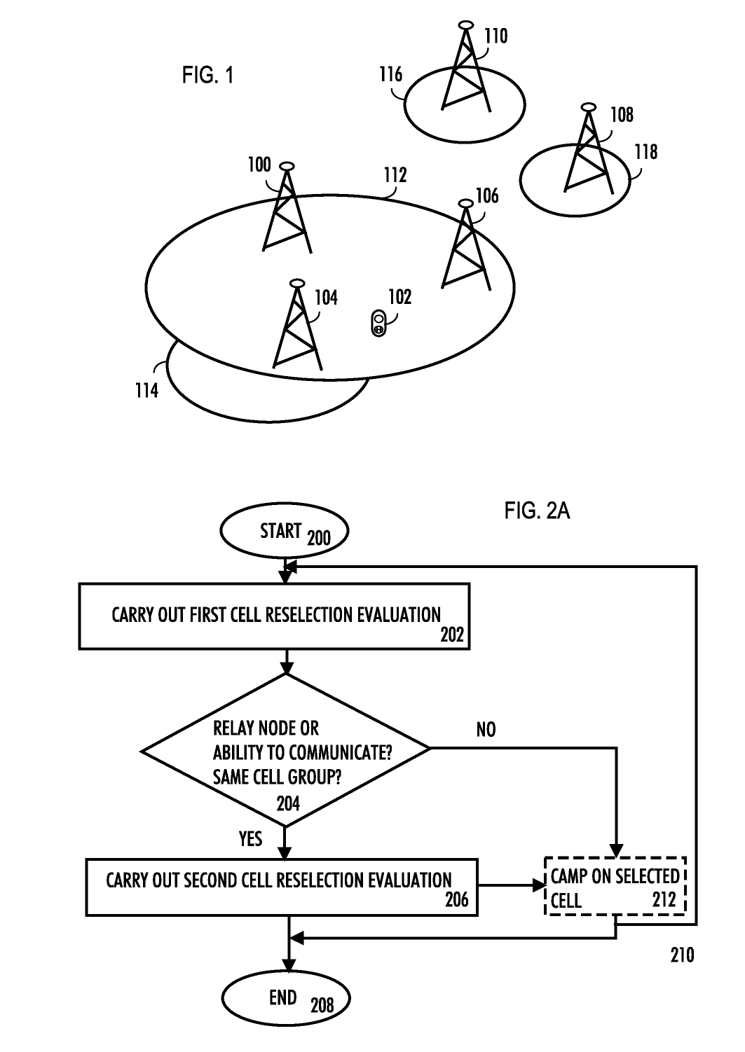

A general architecture of a communication system providing mobility and relay extensions is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not to be discussed in more detail here.

The communications system is a cellular radio system which comprises a long-term evolution (LTE) enhanced node-B (eNB) (base station) 100 which relays traffic of the communications system to other node-Bs or relay nodes 104-110 generating radio cells 112, 116, 118. A relay node 104 generates coverage extension 114 at the cell edge. The node-Bs or relay nodes generate radio connections to user devices, which may be fixed, vehicle-mounted or portable. The user devices may refer to portable computing devices. Such computing devices include wireless mobile communication devices operating with or without a subscriber identification module (SIM), including, but not limited to, the following types of devices: mobile phone, multimedia device, personal digital assistant (PDA), handset. One user device 102 is shown.

The node-B is further connected to other network elements, such as a radio network controller and a core network. Depending on the system, the counterpart on the core network side can be a mobile services switching center (MSC), a media gateway (MGW) or a serving GPRS (general packet radio service) support node (SGSN), etc.

In the future networks, node B and radio network controller functions may be combined in a same network unit and/or at least partly carried out by a user device.

The embodiments are not, however, restricted to the system given as an example but a person skilled in the art may apply the solution to other communication systems provided with the necessary properties. Different radio protocols may be used in the communication systems in which embodiments of the invention are applicable. The radio protocols used are not relevant regarding the embodiments of the invention.

The communication system is also able to communicate with other networks, such as a public switched telephone network or the Internet.

The relay node concept is to also be applied to LTE systems. This causes some challenges and modification needs. The relay node is the switching and controlling element of SAE/LTE (Long Term Evolution (LTE), System Architecture Evolution (SAE)) or other radio access networks. In SAE/LTE, a Node B is called an enhanced B (eNB).

A proper cell selection, or more accurately, reselection is an important issue in the relay node extended networks. As in conventional networks, a user device is able to select a cell according to reselection parameters related for instance to received downlink signal quality as detailed in 3^{rd} Generation partnership Project (3GPP) Technical Specification (TS) 43.022 and 45.008 for GSM/EDGE and in 3GPP TS 36.304 for LTE, etc.

However, some differences also exist. Transmission power of a relay node (RN) is typically assumed to be significantly smaller than that of a base station. Thus, a link between a relay node and a base station may at least occasionally be a bottleneck: a relay node may already serve several terminals with high uplink data rates and the RN-base station (typically an enhanced Node B (eNB)) link is already limited by RN transmission power. On the other hand, a relay node may already serve several terminals with high downlink data rates and the RN-user device (UE) links are already limited by RN transmission power.

Further, a channel quality is different for each RN-eNB link. To achieve the same throughput, larger transmission power and possibly also a larger bandwidth is required for a relay node with a weaker RN-eNB channel quality than for a relay node with a better RN-eNB channel quality. Occasionally, the differences on RN-eNB links may outweigh the differences on UE-RN link in the optimisation of radio resources.

Due to aspects above, another relay node may be a more suitable selection than the relay node indicated by RN-UE link quality. However, these aspects are not visible to a user terminal. On the other hand, the eNB serving the relay nodes may have a sufficient view on the differences based for example on channel quality indicator (CQI) and buffer status reports and on eNB's own channel quality measurements.

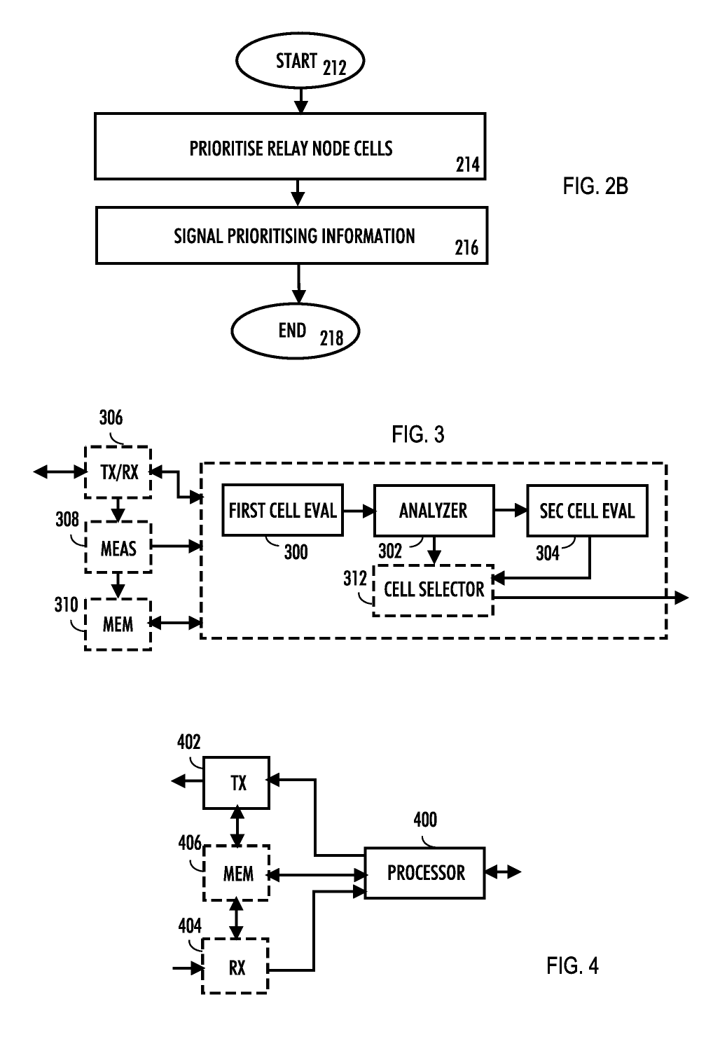

An embodiment of a method is now explained in further details by means of FIG. 2A. The embodiment provides an improved method for cell reselection evaluation.

The embodiment begins in block 200.

With a cell selection, a user device searches for a suitable cell and chooses that cell to provide available services, and tunes to its control channel. This choosing is called as camping on a cell. If the user device finds a more suitable cell, according to cell reselection criteria, it may reselect onto that cell and camp on it.

In block 202, a first cell reselection evaluation process is carried out. The first cell reselection process may be carried out in a plurality of ways. A process according to 3GPP TS 36.304 standard is taken herein as an example. The example does not restrict the implementation of the embodiment, but is used for clarification purposes.

Different types of measurements are typically carried out for cell selection and reselection. A user device may select a suitable cell based on idle mode measurements and cell selection criteria. When camped on a cell, a user device typically regularly searches for a better cell according to the cell reselection criteria.

In order to speed up the cell selection process, stored in formation for several radio access technologies may be available in the user device.

Priorities of different frequencies inside one radio access technology or between different radio access technologies may be provided to a user device in system information and/or optionally in a control message between a network and the user device. Another option is a dedicated signalling message.

A user device may perform ranking of all or a part of cells fulfilling the cell selection criteria. An access to a certain cell may also be restricted from one or a plurality of user devices.

A user device may reselect a new cell if the new cell is better ranked than the serving cell, it has been dropped from the serving cell, etc.

Several cell reselection parameters may be used, such as an offset between two cells or frequencies, minimum required level of a received signal, value of a reselection timer, frequency specific threshold, number of former cell reselections, etc. The cell reselection parameters or at least some of them may be a part of system information broadcasted by a relay node and/or eNB. For instance, offsets, thresholds, etc. may be set by a base station and then signalled to related relay nodes.

When a user device is camped normally, it may carry out the following tasks for a cell reselection evaluation process: select and monitor the indicated paging channels, monitor relevant system information, carry out necessary measurements and execute the cell reselection evaluation.

In block 204, a cell selected in the first cell reselection evaluation process is analysed. The target of the analysis is to determine whether the selected cell is a relay node cell or a cell supported by a node which also supports relay node cells, and is the selected cell supported by a same node (for instance node B) than that of a currently serving cell. In this application, cells supported by a same base station type node, are typically called a cell group.

If the conditions are not fulfilled but a cell for reselection has been found in the first cell reselection evaluation, the process may straight be forwarded to camping on a selected cell (block 212 marked with a dotted line since it does not necessarily belong to the core of the embodiment). Otherwise a second cell reselection evaluation process is triggered.

In block 206, the second cell reselection evaluation process is carried out. The second cell reselection process may be carried out at least partly in a similar manner to the first cell reselection process.

The second cell reselection evaluation process typically comprises the re-ranking of cells supported by a same base station type node (such as a eNB) than the cell selected in the first cell reselection process. This includes cells directly supported by the eNB as well as cells supported by relay nodes which are supported by the eNB in question. This limitation provides an advantage that cell reselection parameters typically specific for the second cell reselection, such as relay node cell offsets, do not have to be determined for the whole of a radio network. In which case one base station type node is able to control the process alone.

Typically, in the second cell reselection evaluation process are used at least one of the following cell reselection parameters: an offset between two cells or frequencies, minimum required level of a received signal, value of a reselection timer, frequency specific threshold, number of former cell reselections, and a relay node cell offset. The relay node cell offset parameter may be the most advantageous in the second cell reselection.

At least some of the second cell reselection specific parameters, such as offsets are readable in the broadcast information of a cell which is typically obtainable in a neighbouring list.

The second cell reselection evaluation improves the system's possibilities to adjust itself to changes in a radio interface. Typically, in a case of a relay node cell, another radio link that is, the link between a relay node and a base station, is involved. Since the transmission power of the relay node may be a restricting factor for radio interface, taking this aspect into consideration typically provides improvements.

After the second cell reselection evaluation, the process may proceed to camping on a selected cell (block 212 marked with a dotted line since it does not necessarily belong to the core of the embodiment). It should be noticed that if no suitable cell is found, the process may continue according to a cell selection process of a currently used standard, such an LTE.

The embodiment ends in block 208. The embodiment is repeatable which is illustrated by using arrow 210 showing one option for repetition.

Another embodiment (starting in block 212 of FIG. 2B) provides a method wherein in block 214 relay node cells are prioritised for a second cell reselection evaluation; and the prioritising information is signalled to relay nodes by a base station type node. The embodiment ends in block 216. The method is repeatable. The prioritising information is usable in the cell reselection evaluation (especially in the second reselection evaluation) described above. The prioritising may at least partially be based on at least one of the following: a load on relay nodes and/or information on quality of channels. The prioritising information may also be a relay node cell offset.

In an embodiment of the invention, user devices are able to recognise a relay node (RN) cell before a random access attempt and identify the RN cell served or supported by a same base station. The base station or node B may prioritise RN cells for a cell reselection based at least partially on: load on the relay nodes and information on quality of channels typically on RN-eNB links as well as on active RN-UE links. For that purpose, a second cell reselection parameter, such as an RN cell offset, may be provided in addition to a normal cell offset. The cell prioritising parameter may simply be an offset value broadcasted by the relay nodes and added to the normal measurement quantity used in cell reselections. Relay nodes and a base station may broadcast the relay node (RN) cell offsets for all normal and RN cells supported by the same node, such as a base station, as a part of neighbouring cell list information. The base station typically sets and signals this parameter to relay nodes.

The steps/points, signalling messages and related functions described above in FIGS. 2A-B are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

The operations illustrate a procedure that may be implemented in one or more physical or logical entities.

Next, an example of an apparatus is explained by means of FIG. 3. It is obvious for a person skilled in the art that the apparatus may also include other parts that those depicted in FIG. 3. The cell reselection process is explained with further details above.

The apparatus of FIG. 3 includes a first cell evaluator 300 configured to carry out a first cell reselection evaluation process. The cell reselection evaluation process is explained above.

The apparatus further includes a cell analyser 302 configured to analyse a cell selected in the first cell reselection evaluation process and to trigger a second cell reselection evaluation process in a case the cell selected in the first cell reselection process is a relay node cell or a cell supported by a node which also supports relay node cells, and the cells are within a same cell group than that of a serving cell.

The apparatus further includes a second cell evaluator 304 configured to carry out the second cell reselection evaluation process. The second cell reselection evaluation process may comprise re-ranking of cells supported by a same base station type node than the cell selected in the first cell reselection process.

Typically, in the second cell reselection evaluation process are used at least one of the following cell reselection parameters: an offset between two cells or frequencies, minimum required level of a received signal, value of a reselection timer, frequency specific threshold, number of former cell reselections, and a relay node cell offset. The relay node cell offset parameter may be the most advantageous in the second cell reselection.

The apparatus may also include a cell selector 312 configured to select a cell on the basis of the second cell reselection evaluation process or on the basis of the first cell reselection process.

A cell analyzer may trigger a cell selection in the cell selector in a case the cell selected in the first cell reselection process is not a relay node cell or not a cell supporting relay node cells within a same cell group than that of a serving cell.

The apparatus may comprise separate units for each separate function, or unit/units may be configured to perform a plurality of functions.

Another option for an apparatus includes means 300 for carrying out a first cell reselection evaluation process, means 302 for analyzing a cell selected in the first cell reselection evaluation process and triggering a second cell reselection evaluation process in a case the cell selected in the first cell reselection process is a relay node cell or a cell supporting relay node cells, and the cells are within a same cell group than that of a serving cell, and means 304 for carrying out the second cell reselection evaluation process. The second cell reselection evaluation process may comprise re-ranking of cells supported by a same base station type node than the cell selected in the first cell reselection process.

The apparatus of another example may also comprise means 312 for selecting a cell on the basis of the second cell reselection evaluation process or on the basis of the first cell reselection process.

The apparatus of another example may comprise separate means for each separate function, or means may be configured to perform a plurality of functions.

The apparatus may be implemented as one or more integrated circuits. Other hardware embodiments are also feasible, such as a circuit built of separate logic components. A hybrid of these different implementations is also feasible.

The apparatus may also be implemented as a processor including necessary software. The apparatus may be a module, or a unit configured as arithmetic operation, or as a program (including an added or updated software routine), executed by a processor. Programs, also called program products, including software routines, applets and macros, can be stored in any apparatus-readable data storage medium and they include program instructions to perform particular tasks. All modifications and configurations required for implementing functionality of an embodiment may be performed as routines, which may be implemented as added or updated software routines, application circuits (ASIC) and/or programmable circuits. Further, software routines may be downloaded into an apparatus. The apparatus may be configured as a computer or a microprocessor, such as single-chip computer element. The program instructions may be coded by a programming language, which may be a high-level programming language, such as C, Java, etc., or a low-level programming language, such as a machine language, or an assembler.

An embodiment provides a computer program embodied on a distribution medium, comprising program instructions which, when loaded into an apparatus, constitute the apparatus as explained above.

The computer program may be in a source code form, object code form, or in some intermediate form, and it may be stored in some sort of a carrier or a distribution medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer (or a processor) or it may be distributed amongst a number of computers.

When selecting the method of implementation, a person skilled in the art will consider the requirements set for the size and power consumption of the apparatus, necessary processing capacity, production costs, and production volumes, for example.

The apparatus may further include or be operationally connectable to a transmitter/receiver 306 for transmitting and receiving signaling or control information to and from a network. For instance, the cell reselection parameters or at least some of them, such as offsets and thresholds, may be a part of system information broadcasted by a relay node or a node B.

The apparatus may also perform different kinds of measurements for cell selection and reselection in a measurement unit 308.

In order to speed up the cell selection process, stored information for several radio access technologies may be available in a memory 310. The memory may be a removable memory detachably coupled to the apparatus.

The apparatus may also be or be placed in a user device which is a piece of equipment or a device that associates, or is arranged to associate, the user device and its user with a subscription and allows a user to interact with a communications system. The user device presents information to the user and allows the user to input information. In other words, the user device may be any device capable of receiving information from and/or transmitting information to the network, connectable to the network wirelessly or via a fixed connection. Examples of the user device include a personal computer, a game console, a laptop (a notebook), a personal digital assistant, a mobile station (mobile phone), and a line telephone. The user device typically include a user interface which may include a microphone, headphones, keypad and/or a screen.

Another embodiment provides an apparatus depicted in FIG. 4, including a processor 400 configured to prioritize relay node cells for a second cell reselection evaluation and a transmitter 402 configured to signal the prioritizing information to relay nodes.

The prioritising may at least partially be based on at least one of the following: a load on relay nodes and/or information on quality of channels. The prioritising information may also be a relay node cell offset.

The apparatus may as an option include means 400 for prioritising relay node cells for a second cell reselection evaluation and means 402 for signalling the prioritising information to relay nodes. The prioritising information is usable in the cell reselection evaluation (especially in the second reselection evaluation) described above.

The apparatus may also include or be operationally connectable to a receiver 404 for receiving information needed for prioritizing and/or a memory 406 for storing the information. A skilled person is aware that the apparatus may also include other parts, such as more processors. The apparatus may be or may be placed in a network node, such as a node B.

The base station or node B may prioritise RN cells for a cell reselection based at least partially on: load on the relay nodes and information on quality of channels on RN-eNB links as well as on active RN-UE links. For that purpose, an RN cell reselection parameter (such as an RN cell offset) exists. The cell prioritising parameter may simply be an offset value broadcasted by the relay nodes and added to the normal measurement quantity used in cell reselections. The base station typically sets and signals this parameter to relay nodes.

The cell prioritising parameter may be added to the normal measurement quantity used in cell reselections. Relay nodes and a base station may broadcast the relay node (RN) cell offsets for all normal and RN cells supported by the same node, such as a base station, as a part of neighbouring cell list information.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, implementation can be through modules of at least one chip set (e.g., procedures, functions, and so on) that perform the functions described herein. The software codes may be stored in a memory unit and executed by processors. The memory unit may be implemented within the processor or external to the processor. In the later case it can be communicatively coupled to the processor via various means, as is known in the art. Additionally, components of systems described herein may be rearranged and/or complimented by additional components in order to facilitate achieving the various aspects, etc., described with regard thereto, and they are not limited to the precise configurations set forth in given Figures, as will be appreciated by one skilled in the art.

It will be obvious to a person skilled in the art that, as technology advances, the inventive concept can be implemented in various ways. The invention and its embodiments are not limited to the examples described above but may vary within the scope of the claims.

1. An apparatus comprising:
a first cell evaluator configured to carry out a first cell reselection evaluation process;
a cell analyzer configured to analyze a cell selected in the first cell reselection evaluation process and to trigger a second cell reselection evaluation process in a case the cell selected in the first cell reselection process is a relay node cell or a cell supported by a node which node also supports relay node cells, and the cell is within a same cell group than that of a serving cell; and
a second cell evaluator configured to carry out the second cell reselection evaluation process.

2. The apparatus of claim 1, wherein the second cell evaluator is further configured to carry out the second reselection evaluation process by re-ranking the cells supported by a same node than the cell selected in the first cell reselection process.

3. The apparatus of claim 1, the apparatus further comprising: a cell selector configured to select a cell on the basis of the second cell reselection evaluation process or on the basis of the first cell reselection process.

4. The apparatus of claim 1, wherein the cell analyser is further configured to trigger a cell selection in the cell selector in a case the cell selected in the first cell reselection process is not a relay node cell or not a cell supporting relay node cells within a same cell group than that of a serving cell.

5. The apparatus of claim 1, the second cell evaluator uses in the second cell reselection evaluation process at least one of the following cell reselection parameters: an offset between two cells or frequencies, minimum required level of a received signal, value of a reselection timer, frequency specific threshold, number of former cell reselections, and a relay node cell offset.

6. The apparatus of claim 1, wherein at least some of the cell reselection parameters are readable in the broadcast information of a cell obtainable in a neighbouring list.

7. The apparatus of claim 1, the apparatus being a processor.

8. The apparatus of claim 1, the apparatus being a chip set.

9. The apparatus of claim 1, the apparatus being a user terminal further comprising a user interface.

10. A computer program product comprising program instructions which, when loaded into the apparatus, constitute the modules of claim 1.

11. A method comprising:
carrying out a first cell reselection evaluation process;
analyzing a cell selected in the first cell reselection evaluation process and triggering a second cell reselection evaluation process in a case the cell selected in the first cell reselection process is a relay node cell or a cell supported by a node which node also supports relay node cells, and the cell is within a same cell group than that of a serving cell; and
carrying out the second cell reselection evaluation process.

12. The method of claim 11, wherein the second cell reselection evaluation process further comprises re-ranking the cells supported by a same node than the cell selected in the first cell reselection process.

13. The method of claim 11, the method further comprising: selecting a cell on the basis of the second cell reselection evaluation process or on the basis of the first cell reselection process.

14. The method of claim 11, further comprising triggering the cell selection in a case the cell selected in the first cell reselection process is not a relay node cell or not a cell supporting relay node cells within a same cell group than that of a serving cell.

15. The method of claim 11, further comprising using in the second cell reselection evaluation process at least one of the following cell reselection parameters: an offset between two cells or frequencies, minimum required level of a received signal, value of a reselection timer, frequency specific threshold, number of former cell reselections, and a relay node cell offset.

16. An apparatus, comprising:
a processor configured to prioritise relay node cells for a second cell reselection evaluation;
a transmitter configured to signal the prioritising information to relay nodes normal cells supported by a same node.

17. The apparatus of claim 16, wherein the prioritising information is a relay node cell offset.

18. The apparatus of claim 16, wherein the prioritising is at least partially based on at least one of the following: a load on relay nodes and information on quality of channels.

19. An apparatus comprising:
means for carrying out a first cell reselection evaluation process; means for analyzing a cell selected in the first cell reselection evaluation process and triggering a second cell reselection evaluation process in a case the cell selected in the first cell reselection process is a relay node cell or a cell supported by a node which node also supports relay node cells, and the cell is within a same cell group than that of a serving cell; and
means for carrying out the second cell reselection evaluation process.

20. The apparatus of claim 19, wherein the second cell reselection evaluation process further comprises re-ranking the cells supported by a same node than the cell selected in the first cell reselection process.

21. The apparatus of claim 19, the apparatus further comprising:
means for selecting a cell on the basis of the second cell reselection evaluation process or on the basis of the first cell reselection process.

22. The apparatus of claim 19, further comprising means for triggering the cell selection in a case the cell selected in the first cell reselection process is not a relay node cell or not a cell supporting relay node cells within a same cell group than that of a serving cell.

23. The apparatus of claim 19, further comprising using in the second cell reselection evaluation process at least one of the following cell reselection parameters: an offset between two cells or frequencies, minimum required level of a received signal, value of a reselection timer, frequency specific threshold, number of former cell reselections, and a relay node cell offset.

24. An apparatus, comprising:
means for prioritising relay node cells for a second cell reselection evaluation;
means for signalling the prioritising information to relay nodes and/or normal cells supported by a same node.

25. The apparatus of claim 24, wherein the prioritising information is a relay node cell offset.

26. The apparatus of claim 24, wherein the prioritising is at least partially based on at least one of the following: a load on relay nodes and information on quality of channels.

27. A method, comprising:
prioritising relay node cells for a second cell reselection evaluation;
signalling the prioritising information to relay nodes and/or normal cells supported by a same node.

28. The method of claim 27, wherein the prioritising information is a relay node cell offset.

29. The method of claim 27, wherein the prioritising is at least partially based on at least one of the following: a load on relay nodes and/or information on quality of channels.
